(19) United States
(12) Patent Application Publication
(10) Pub. No.: US 2025/0351231 A1
(43) Pub. Date: Nov. 13, 2025

(54) HAIRSTYLING APPARATUS WITH POWER ELECTRONIC CONVERTER

(71) Applicant: Dyson Technology Limited, Malmesbury, Wiltshire (GB)

(72) Inventor: Michael James WAITE, Cirencester (GB)

(21) Appl. No.: 18/868,493

(22) PCT Filed: May 18, 2023
(86) PCT No.: PCT/IB2023/055113

§ 371 Date: Nov. 22, 2024

(30) Foreign Application Priority Data
May 25, 2022 (GB) 2207672.3

(51) Int. Cl. H05B 1/02; A45D 20/10

(52) U.S. Cl. CPC H05B 1/0252; A45D 20/10

(57) ABSTRACT

A hairstyling apparatus includes a heater having at least one heating element. A sensing circuit determines a voltage of a mains power supply and outputs a signal indicative of the determined voltage. A power electronic converter converts the mains power supply to a heater drive signal for driving the heater at least partly in reliance on the signal.

### FIELD

The present invention relates to a hairstyling apparatus that uses heat, and optionally moving air, to dry and/or style hair.

### BACKGROUND

Hairstyling apparatuses such as hairdryers and hair straighteners use heat to allow styling of a user's hair. For example, a hairdryer heats air that is blown out of a nozzle onto hair to be dried/styled. A hair straightener heats one or more plates that are arranged to allow a tress of hair to be tensioned and drawn through the plate(s) to straighten it.

It is desirable for a hairstyling apparatus to be usable in jurisdictions having different mains voltages. For example, a switch may allow a user to place the hairstyling apparatus into a low voltage (e.g., nominally 120 Vac) or a high voltage (e.g., nominally 230 Vac) mode, depending upon the local mains supply voltage.

### SUMMARY

In accordance with a first aspect, there is provided a hairstyling apparatus comprising:
a heater comprising at least one heating element;
a sensing circuit for determining a voltage of a mains power supply, and outputting a signal indicative of the determined voltage; and
a power electronic converter for converting the mains power supply to a heater drive signal for driving the heater, at least partly in reliance on the signal.

By controlling an output of the power electronic converter in reliance on the signal, user error in selecting a regional voltage may be avoided.

The hairstyling apparatus may comprise a heating element drive circuit for generating a further drive signal for driving at least one of the at least one heating elements, the heating element drive circuit not forming part of the power electronic converter.

The heating element drive circuit and the power electronic converter may be configured and connected to drive different sets of the heating elements.

The power electronic converter may be configured to output a fixed output voltage for a range of mains power supply voltages. This may allow reliable operation of the hairstyling apparatus with a range of mains power supply voltages. In this context, a “fixed output voltage” includes a DC voltage with little or no voltage ripple, and also a varying voltage that has a fixed average, or RMS, voltage. For example, the output may be AC, or DC with a ripple of up to 100%, depending upon the filter (if any) at the output of the electronic power converter.

An output voltage of the power electronic converter may be varied at least partly in reliance on a currently selected mode or setting of the hairstyling apparatus. This may allow heater control without the need for current modulating components such as TRIACS.

The power electronic converter may be an AC to DC converter, or an AC to AC converter.

The power electronic converter may be a buck-boost converter, a buck converter, a boost converter, or any other form of power electronic converter.

The hairstyling apparatus may comprise a power factor correction circuit for power factor correction of the power electronic converter and associated load(s).

The hairstyling apparatus may be capable of accepting a mains power supply having an AC voltage of 85 Vac to 264 Vac.

In accordance with a second aspect, there is provided a method of controlling a power output of a hairstyling apparatus comprising:
a heater comprising at least one heating element; and
a power electronic converter for converting a mains power supply to a heater drive signal for driving the heater;
the method comprising:
determining a voltage of a mains power supply to which the hairstyling apparatus is connected; and
controlling the power electronic converter at least partly in reliance on the determined voltage.

The hairstyling apparatus may comprise a heating element drive circuit that does not form part of the power electronic converter, and the method may comprise generating, with the heating element drive circuit, a further drive signal for driving at least one of the at least one heating elements.

The method may comprise driving different sets of the heating elements with the heating element drive circuit and the power electronic converter.

Controlling the power electronic converter may comprise outputting a fixed output voltage for a range of input voltages. In this context, a “fixed output voltage” includes a DC voltage with little or no voltage ripple, and also a varying voltage that has a fixed average, or RMS, voltage. For example, the output may be AC, or DC with a ripple of up to 100% depending upon the filter (if any) at the output of the electronic power converter.

Controlling the power electronic converter may comprise varying an output voltage of the power electronic converter at least partly in reliance on a currently selected mode or setting of the hairstyling apparatus.

The method may comprise converting, using the power electronic converter, the mains supply to an AC heater drive signal.

The method may comprise converting, using the power electronic converter, the mains supply to a DC heater drive signal.

The method may comprise power factor correcting the power electronic converter.

### BRIEF DESCRIPTION OF DRAWINGS

In order that the present invention may be more readily understood, embodiments of the invention will now be described, by way of example, with reference to the accompanying drawings, in which:

FIG. 1 is a schematic diagram showing a hairstyling apparatus;

FIG. 2 is a schematic diagram showing a further hairstyling apparatus;

FIG. 3 is a schematic diagram showing a hairstyling apparatus in the form of a hairdryer; and

FIG. 4 is a schematic diagram showing a hairstyling apparatus in the form of a hair straightener;

FIG. 5 is a flowchart showing a method of controlling a power output of a hairstyling apparatus;

FIG. 6 includes three charts showing various levels of DC ripple in different implementations of an AC to DC power electronic converter; and

FIG. 7 is a schematic diagram of an alternative implementation comprising a heating element drive circuit.

### DETAILED DESCRIPTION

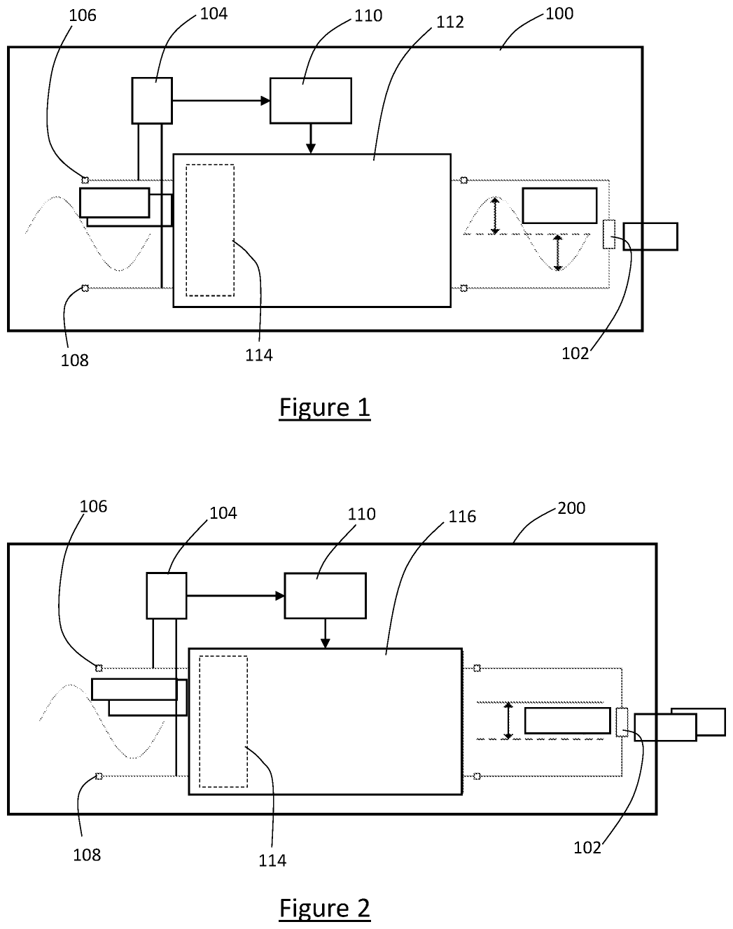

Referring to the drawings, and FIG. 1 in particular, there is shown a hairstyling apparatus 100. Hairstyling apparatus 100 may take any suitable form, such as a hairdryer, hair straightener, hair curling wand, or any other apparatus that uses heat to dry, style, or straighten hair.

Hairstyling apparatus 100 comprises a heater in the form of an electrical resistance heating element 102. Heating element 102 may use a high-resistance alloy, such as nichrome, in form of, for example, one or more wires, ribbons or traces, which may be mounted on, or supported by, a suitable substrate, such as a ceramic former or PCB.

Two or more heating elements may be provided in series, parallel, or some combination thereof, to achieve the required current and power ratings given the range of expected operating voltages.

Hairstyling apparatus 100 includes a sensing circuit in the form of a voltage sensor 104, which is connected across input terminals 106 and 108. When hairstyling apparatus 100 is plugged into a mains power supply (not shown), input terminals 106 and 108 are provided with the mains power supply voltage. Depending upon geographical region, mains power supply voltage may be nominally 120 VAC (for example, in North America) or nominally 230 VAC (for example, in Europe). Other nominal mains power supply voltages, such as 110 Vac, 220 Vac, and 240 Vac, for example, may apply.

Although described as being connected across input terminals 106 and 108, voltage sensor 104 can be connected and configured to determine a voltage at any suitable point in hairstyling apparatus 100. For example, the voltage can be determined at the output of a voltage conversion circuit (not shown), where such a circuit is used. Such a voltage conversion circuit can include, for example, a voltage divider (which provides a scaled output voltage), a passive bridge rectifier, or an active bridge rectifier.

The signal is supplied from voltage sensor 104 to a controller 110. In reliance on the signal, controller 110 outputs a control signal to a power electronic converter 112. Power electronic converter 112 is configured to convert the mains power supply to a heater drive signal for driving heating element 102.

Voltage sensor 104 is configured to determine the mains power supply voltage at input terminals 106 and 108, and to output a signal indicative of that voltage. The signal can take any suitable form. For example, the signal may be an analogue voltage that can be converted to a numerical value by an analogue-to-digital converter, which may form part of controller 110, or can be a separate circuit. Alternatively, the signal may be a numerical value that can directly be read by controller 110.

In yet other implementations, the signal can be used directly without conversion to a numerical value, for example by taking the form of a variable voltage that directly controls one or more other elements of the power electronics converter.

In hairstyling apparatus 100, power electronic converter 112 is configured to output an AC heater drive signal for driving heating element 102. Power electronic converter 112 may take the form of, for example, a controllable AC buck-boost converter. The circuit details and operating principles of AC buck-boost converters are well known to those skilled in the art, and so will not be described in detail. However, a buck converter, a boost converter, or any other form of power electronic converter may also be used, depending upon implementation requirements.

Controller 110 controls, in reliance on the signal, the output of power electronic converter 112. In the implementation of FIG. 1, power electronic converter 112 is controlled to output a fixed AC voltage. The AC voltage is selected to suit the particular implementation requirements, including factors such as component and conductor current ratings, insulation, heating element specifications, and the like.

The fixed AC voltage causes AC current to flow through heating element 102, thereby causing heating element 102 to become hotter. The heat from heating element 102 can be used to heat air (in the case of, for example, a hairdryer) or a plate (in the case of, for example, a hair straightener). Other hairstyling appliances may use the heat differently.

A “fixed output voltage” includes a varying voltage that has a fixed average, or RMS, voltage. This includes both an AC voltage and a DC voltage having substantial ripple.

Hairstyling apparatus 100 can therefore be plugged into a mains power supply outlet without needing to manually select the operating voltage of hairstyling apparatus 100.

Optionally, hairstyling apparatus 100 may include a power factor correction circuit 114 for power factor correction of the power electronic converter and associated load(s).

Power factor correction circuits are understood from other unrelated fields of art, and so will not be described in detail.

Alternatively, hairstyling apparatus 100 may be configured such that the output voltage of power electronic converter 112 is varied at least partly in reliance on a currently selected mode or setting of hairstyling apparatus 100.

For example, hairstyling apparatus 100 may offer two or more user-selectable modes, each mode having a different temperature or power requirement for heating element 102. Power electronic converter 112 may be controlled by controller 110 such that power electronic converter 112 outputs a lower voltage for a mode having a relatively low temperature or power requirement, and a higher voltage for a mode having a relatively high temperature or power requirement. In this manner, the temperature or power of heating element 102 may be controlled without the need for further power-modulating components such as TRIACS or other power switches.

Power electronic converter 112 may comprise, for example, a buck-boost converter, although any other suitable form of power electronic converter may be employed to suit the particular implementation.

Turning to FIG. 2, there is shown a further hairstyling apparatus 200. Hairstyling apparatus 200 shares several components with hairstyling apparatus 100, and like components are designated with the same reference signs in FIGS. 1 and 2. The phrase “like components”, as used here and elsewhere in this description, is not intended to mean that components with the same reference sign are identical. For example, a heating element for a hairdryer may have a different form and be of a higher power than a heating element for a hair straightener, but both are like components given that they are both heating elements performing a heating function.

Power electronic converter 112 of hairstyling apparatus 100 outputs AC. In contrast, hairstyling apparatus 200 comprises a power electronic converter 116 that is configured to output DC.

As with power electronic converter 112, power electronic converter 116 may be configured to output a fixed output voltage for a range of input mains power supply voltages, although the fixed output voltage is a DC voltage rather than an AC voltage.

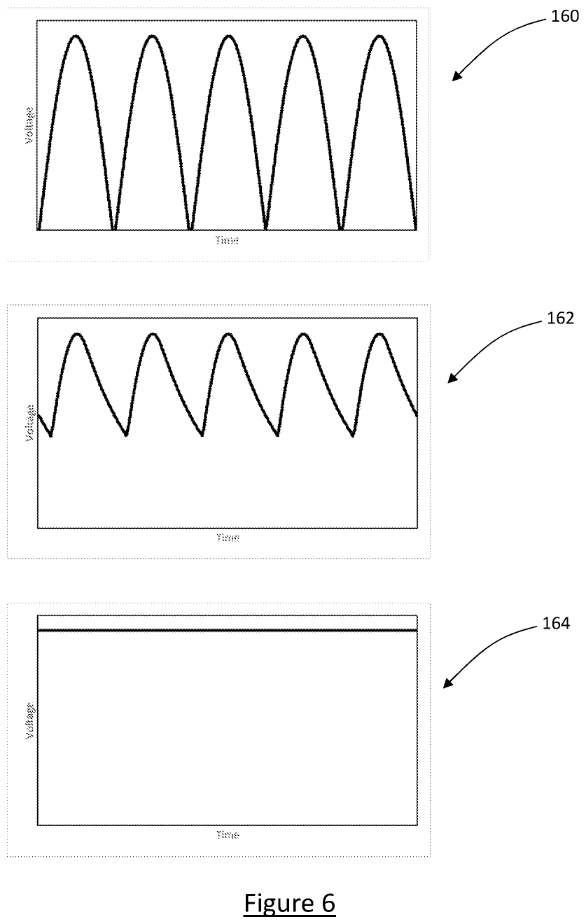

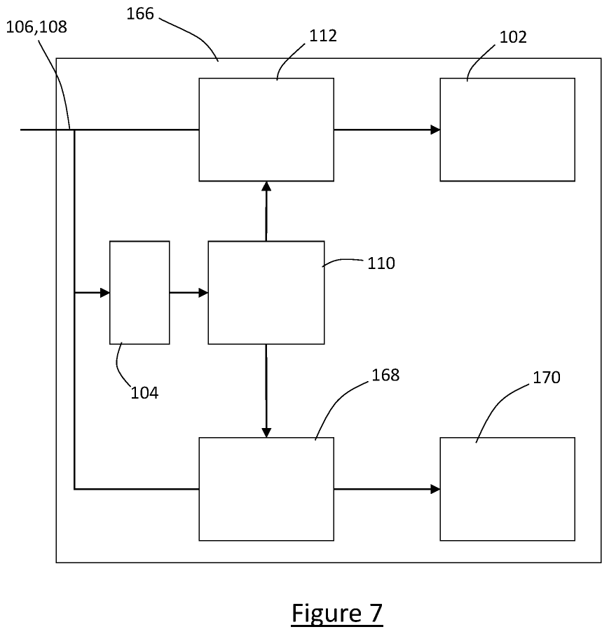

Again, a “fixed output voltage” includes a fixed average, or RMS, voltage, which in this implementation is a DC voltage. The DC voltage may have little or no voltage ripple, or may have a ripple of up to 100% depending upon the filter (if any) at the output of the electronic power converter. For example, as shown in FIG. 6, the power electronic converter may output a DC voltage with 100% ripple as shown in the first graph 160, about 50% ripple as shown in the second graph 162, or little-to-no ripple as shown in the third graph 164. In each case, there is a fixed (in RMS terms) voltage output by the power electronic converter.

Alternatively, power electronic converter 116 may be configured to output a variable voltage. For example, hairstyling apparatus 200 may offer two or more user-selectable modes, each mode having a different temperature or power requirement for heating element 102. Power electronic converter 116 may be controlled by controller 110 such that power electronic converter 116 outputs a lower voltage for a mode having a relatively low temperature or power requirement, and a higher voltage for a mode having a relatively high temperature or power requirement. In this manner, the temperature or power of heating element 102 may be controlled without the need for further power-modulating components such as field effect transistors.

In both hairstyling apparatus 100 and hairstyling apparatus 200, power electronic converters 112 and 116 are capable of accepting a mains power supply having an AC voltage of 85 VAC to 264 VAC. However, the skilled person will appreciate that power electronic converters having different input voltage operating ranges may be used in other implementations.

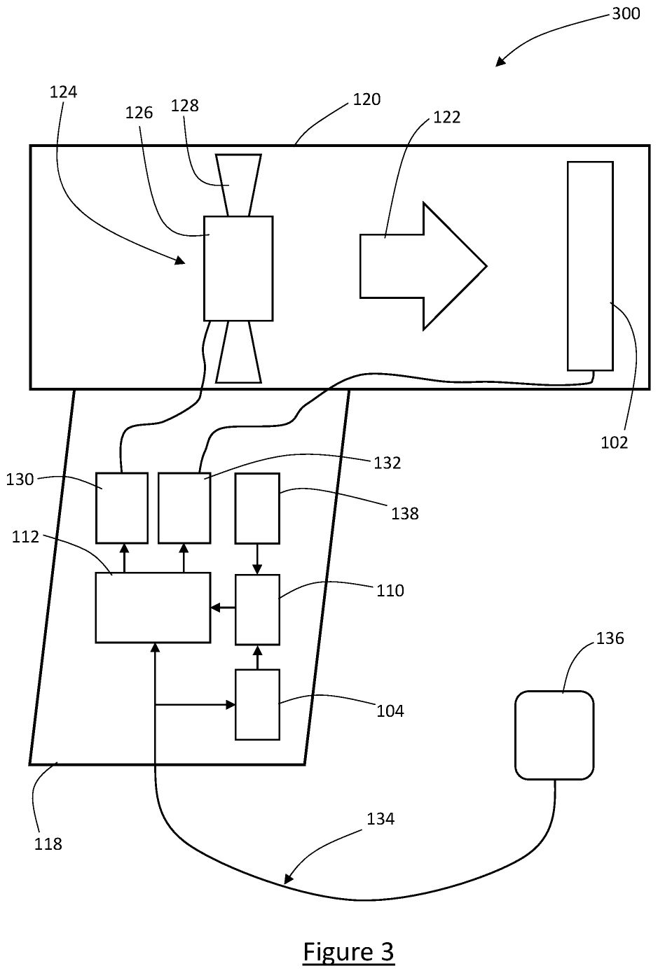

Turning to FIG. 3, there is shown a hairstyling apparatus in the form of a hairdryer 300. Hairdryer 300 shares several components with hairstyling apparatus 100 and 200, and like components are designated with the same reference signs in FIGS. 1, 2 and 3.

Hairdryer 300 comprises a handle 118 connected to a tubular body 120. Body 120 defines an airflow path 122, within which is disposed a fan unit 124 comprising an electric motor 126, and an impeller 128 connected to be driven by electric motor 126. Heating element 102 is disposed within airflow path 122, downstream of fan unit 124.

Handle 118 houses voltage sensor 104, controller 110 and power electronic converter 112. Handle 118 houses a motor driver 130 configured to drive fan unit 124 in accordance with drive signals received from controller 110. Handle 118 also houses a heater driver 132 comprising TRIACs (not shown). The TRIACs are connected to receive the AC output of power electronic converter 112, and to modulate the AC output in accordance with heater control signals from controller 110.

Controller 110 may use, for example, a burst fire control scheme (combination of half and/or full mains cycle conduction periods, potentially with gaps between conductions), a phase control scheme (partial conduction periods, usually via changing the start of conduction point), a combination thereof, or any other suitable control scheme for controlling the TRIACs. TRIAC control schemes are well known to those skilled in the art, and so will not be described in detail.

A user interface 138 is provided on handle 118, and comprises, for example, a switch (not shown) enabling a user to select one of three heating modes: off, low power, and high power. In the “off” mode, no power is supplied to heating element 102, and so the air blown by fan unit 124 exits body 120 without being significantly heated (there may be some minor heat increase caused by the air cooling motor 126).

Other user interface elements may be used as an alternative, or in addition, to a switch. For example, one or more dials, sliders, buttons, touch surfaces, or other input elements may be provided as part of a user interface. The user interface may also provide feedback via one or more screens, lights, sounds, or the like.

In the “low power” mode, controller 110 controls heater driver 132 such that the TRIACs conduct for about half a cycle (on average), resulting in heating element 102 outputting about half power the available power from power electronic converter 112. In the “high power” mode, controller 110 controls heater driver 132 such that the TRIACs conduct continuously, resulting in heating element 102 outputting the full available power from power electronic converter 112.

In other implementations, any number of heater settings may be provided for user selection via a user interface, with a suitable heater power output or temperature for each heater setting.

The speed of fan unit 124 may also be controlled in accordance with a mode or setting selected by a user via user interface 138. Fan speed may be a separate setting, or may form one element of a mode comprising settings for fan speed and heater setting, for example.

A mains power cable 134 exits handle 118, and terminates in a mains power plug 136. Plug 136 is configured in accordance with whichever standard applies for the region within which hairdryer 300 is to be operated. The other end of cable 134 supplies mains power to internal components of hairdryer 300.

In alternative implementations, the sensing circuit can identify the mains voltage indirectly. For example, the electrical plug may comprise an ID component configured to provide an ID data item. The sensing circuit comprises an ID reader configured to read the ID component, wherein the controller is operable to determine a mains voltage associated with the electrical plug by way of the ID component.

The electrical plug can include a plug body including the sensing circuit, and a removable plug terminal. By providing different plug terminal types for different country plug/socket standards, the hairstyling apparatus is able to determine the mains voltage based on which plug terminal is connected to the plug body. For example, a British plug type indicates that 240V mains is to be expected, whereas a US plug type indicates that 120V mains is to be expected.

The plug body may be integrated into the main body of the hairstyling apparatus. However, in other implementations, the plug body may be positioned at the tail end of an electrical cable extending from the main body of the hairstyling apparatus.

The ID component and the ID reader may take various forms. For example, the ID reader may be a vision-based system that is configured to recognise a visual marker or indicia of some type constituting the ID component. In other examples, the ID component may be a series of bumps or protrusions, similar to a Braille system, the configuration of which represents a data item. Similarly, the ID reader may include an array of microswitches configured to be responsive to the bump array to detect the ID data item.

In a particularly flexible example, the ID component is a data processing component such as an RFID transponder/tag which is configured to transmit the ID data item to the ID reader, which may be constituted by an RFID receiver. The ID component is configurable to store and transmit manufacturer-defined data to the ID reader, thereby to allow identification of the mains voltage. This may be direct (that is, the mains voltage is sent as a numerical value) or indirect (that is, the ID component identifies a country, plug terminal, or other information, based upon which the hairstyling apparatus can look up the corresponding mains voltage).

The ID reader can be located at the plug body. However, this is not essential, and it is envisaged that the ID reader can be located at other positions on the hairstyling apparatus, for example on the main body. The position of the ID reader may depend on various factors. Positioning the ID reader on the plug body, close to the plug terminal, means that a relatively low power RFID tag may be used, for example a passive tag that is able to work at short transmission distances. So called ‘active’ RFID tags, having a self-contained power source rather than scavenging power from an RFID transceiver as is the case with a passive tag, have the capability of transmission over greater distances, which makes them appropriate for use in hairstyling apparatus where a larger distance between the ID component and the ID reader is desirable.

In alternative implementations, hairdryer 300 can omit heater driver 132. In one such implementation, heating element 102 is driven at only a single, fixed power, established by the output voltage of power electronic converter 112. An output temperature of heated air from hairdryer 300 is then a function of that power and the airflow rate.

In another such implementation, the output voltage of power electronic converter 112 is controllable by controller 110 as described above in relation to FIG. 1. An output temperature of heated air from hairdryer 300 is then a function of the voltage output by power electronic converter 112 and the airflow rate.

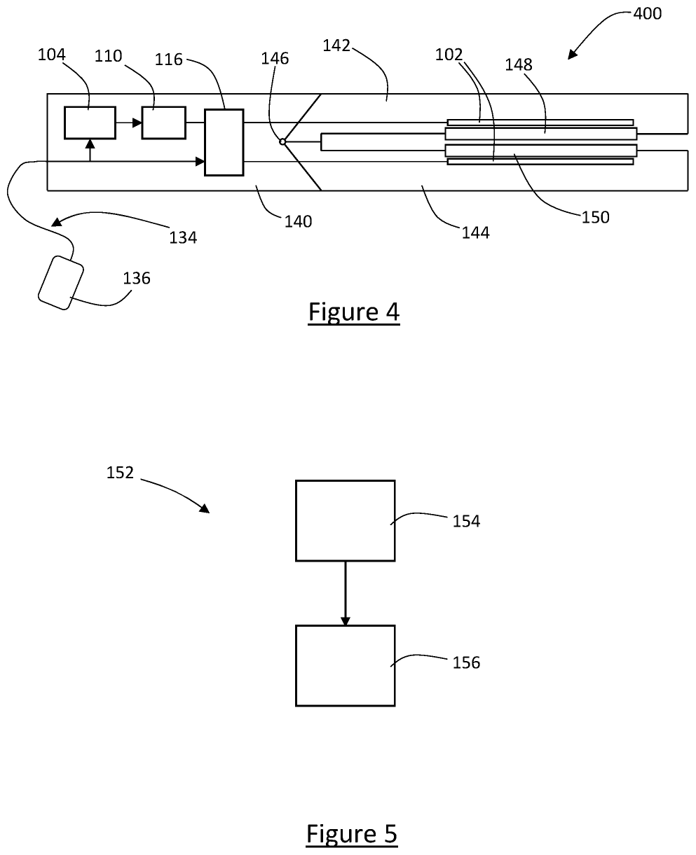

Turning to FIG. 4, there is shown a hairstyling apparatus in the form of a hair straightener 400. Hair straightener 400 shares several components with hairstyling apparatus 100, 200, and 300, and like components are designated with the same reference signs in FIGS. 1, 2, 3, and 4.

Hair straightener 400 comprises a handle 140 within which is disposed voltage sensor 104, controller 110, and power electronic converter 116.

Hair straightener 400 comprises a first arm 142 and a second arm 144. First arm 142 and second arm 144 are connected to handle 140 at a hinge 146, such that the arms can pivot away from each other.

First arm 142 includes a first plate 148 and second arm 144 includes a second plate 150. First plate 148 and second plate 150 are formed from a heat-conductive material, and may include a non-stick coating. Optionally, one or both of first plate 148 and second plate 150 may be flexible along their length(s), to conform to, and place pressure upon, hair trapped between them when hair straightener 400 is in use.

Hair straightener 400 comprises two heating elements 102, each being positioned along one of first plate 148 and second plate 150.

A spring (not shown) biases the arms away from each other, such that a user can position a tress of hair between first plate 148 and second plate 150, and then squeeze first and second arms 142 and 144 together to capture the tress of hair between first plate 148 and second plate 150.

In contrast to hairdryer 300, hair straightener 400 does not include any form of heater driver between power electronic converter 116 and heating elements 102. Instead, heating elements 102 are driven directly by power electronic converter 116.

In an implementation, the output voltage of power electronic converter 116 of hairdryer 300 is controllable by controller 110 as described above in relation to FIG. 2. A temperature of first plate 148 and second plate 150 is then a function of the voltage output by power electronic converter 116 and heat losses to hair and the surroundings.

In another implementation, heating elements 102 of hairdryer 300 are driven at a single, fixed power, established by a fixed output voltage of power electronic converter 116. A temperature of first plate 148 and second plate 150 is then a function of that output voltage and heat losses to hair and the surroundings.

Although hairdryer 300 has been described as using power electronic converter 112 (AC to AC) and hair straightener 400 has been described as using power electronic converter 116 (AC to DC), the skilled person will appreciate that either type of power electronic converter may be used in any hairstyling apparatus application.

In addition, an AC or DC output of the power electronic converter may have its average or RMS voltage controlled by various modulation schemes, including burst fire, phase control, pulse-width modulation, or the like.

Particular advantages may arise from the use of a variable-voltage output power electronic converter in relatively low power applications. In this context, “low power” means having an average output power of less than about 500 W, although in other approaches, “low power” means having an average power output of less than about 400 W, 250 W, or even 200 W.

Many hairdryers, for example, have relatively high heat output requirements, at times exceeding a kilowatt. In at least some implementations, such high power requirements may make it expensive to provide a variable-voltage output power electronic converter. The lower heat output requirements of a typical hair straightener, on the other hand, may make the use of a variable-voltage output power electronic converter more desirable.

Although “buck-boost” power electronic converters have been referred to, the skilled person will appreciate that other forms of power electronic converters may be used. For example, a power electronic converter that only bucks or boosts an input mains power supply voltage may be used. Other forms of voltage increasing and/or decreasing circuits may also be used.

Any suitable type of controller may be used. For example, controller 110 may take the form of a microprocessor (with associated support circuitry if required), a microcontroller, or any suitable combination of analogue and/or digital hardware, and/or software.

For the sake of clarity, some non-critical implementation details are omitted from FIGS. 1-4. For example, controller 110 may require a DC power supply, but this is omitted from the drawings to avoid unnecessary clutter. One or more temperature sensors may be used to control the temperature of any or all heating elements, air that is heated by the one or more heating elements, components heated by the one or more heating elements (e.g., plates in a hair straightener), ambient temperature, any other temperature, or any combination thereof.

The skilled person will appreciate that all drawings are schematic in nature, and are not to scale. In relation to FIGS. 4 and 5 in particular, the locations of particular components within the hairstyling apparatuses are exemplary only, and may vary depending upon implementation.

For example, although the user interface 138 is shown schematically as a single component located in/on handle 118, user interface 138 may alternatively be located elsewhere in/on the hairstyling apparatus, including being distributed across different locations in/on the hairstyling apparatus. Similar comments apply to other components.

One or more components of the hairstyling apparatus may be located in a separate housing. Mains power cable 134 is connected to the separate housing. A further cable (not shown) connects the separate housing to the the hairstyling apparatus. A component such as motor driver 130, for example, may be located in the separate housing. In that case, the further cable carries power for the hairstyling apparatus, and motor drive signals from motor driver 130. One or more other components of the hairstyling apparatus, such as controller 110 (or a sub-controller or circuit forming part of controller 110) or power electronic converter 116, may also be contained within the separate housing.

Turning to FIG. 7, there is shown an alternative implementation of a hairstyling apparatus 166. Hairstyling apparatus 166 includes a heating element drive circuit 168 and a further heating element 170.

Heating element drive circuit 168 is controlled by controller 110 and is configured to generate a further drive signal for driving further heating element 170. Heating element drive circuit 168 and power electronic converter 112 are configured and connected to drive different sets of the heating elements. Heating element drive circuit 168 does not form part of power electronic converter 112.

Heating element drive circuit 168 can comprise any suitable circuit for generating a further drive signal for heating element 170. For example, heating element drive circuit 168 can include one or more switching elements or circuits, such as TRIACS, MOSFETs, relays, or the like, controlled by controller 110 so as to drive heating element 170 as required. Heating element drive circuit can also take the form of a further power electronic converter. The further drive signal can be AC or DC, including power-modulated AC or DC.

Although heating elements 102 and 170 of hairstyling apparatus 166 are connected to be driven separately by power electronic converter 112 and heating element drive circuit 168 respectively, the skilled person will appreciate that, in other implementations, the heating elements can be connected such that at least one of them can be driven by both the heating element drive circuit and the power electronic converter.

Turning to FIG. 5, there is shown a method 152 of controlling a power output of a hairstyling apparatus. Method 152 can be performed by, for example, a controller such as controller 110 described above. The method can be embodied in analogue or digital hardware, firmware, or software, or any combination thereof.

The hairstyling apparatus may comprise a heater comprising at least one heating element, and a power electronic converter for converting a mains power supplied to a heater drive signal for driving the heater.

Method 152 comprises determining 154 a voltage of a mains power supply to which the hairstyling apparatus is connected, and controlling 156 the power electronic converter at least partly in reliance on the voltage determined voltage.

Step 156 may optionally comprise outputting a fixed output voltage for a range of different input voltages.

Alternatively, step 156 may optionally comprise varying an output voltage of the power electronic converter at least partly in reliance on a currently selected mode or setting of the hairstyling apparatus.

Step 156 may comprise converting, using the power electronic converter, the mains supply to an AC heater drive signal or to a DC heater drive signal.

Optionally, method 152 may comprise power factor correcting the power electronic converter.

Although the sensing circuit has been described as a voltage sensor, the skilled person will appreciate that the term “sensing circuit” is used broadly. Within the context of this application, “sensing circuit” includes any combination of circuits and/or components that outputs one or more signals that are directly or indirectly indicative of the voltage of the mains supply to which the hair styling apparatus is connected, or is to be connected.

The signal being “indicative” of the voltage is also used broadly, and includes directly indicative and indirectly indicative. “Directly indicative” includes, for example, an arrangement in which the sensing circuit outputs an analogue or digital signal indicative of a specific mains voltage or range of voltages. “Indirectly indicative” means that the output of the sensing circuit is dependent upon the mains voltage, but does not directly represent it. For example, the sensing circuit may measure current at a particular point, where the current varies based on the mains voltage. The sensing circuit may measure a temperature of a particular component or components, where the temperature varies based on the mains voltage. It is not necessary to explicitly convert a current or temperature signal to voltage before using it.

Although the invention has been described with reference to various implementations, the skilled person will appreciate that the invention may be embodied in many other forms, limited only by the scope of the claims.

1. A hairstyling apparatus comprising:
a heater comprising at least one heating element;
a sensing circuit for determining a voltage of a mains power supply, and outputting a signal indicative of the determined voltage; and
a power electronic converter for converting the mains power supply to a heater drive signal for driving the heater, at least partly in reliance on the signal.

2. The hairstyling apparatus of claim 1, comprising a heating element drive circuit for generating a further drive signal for driving at least one of the at least one heating elements, the heating element drive circuit not forming part of the power electronic converter.

3. The hairstyling apparatus of claim 2, wherein the heating element drive circuit and the power electronic converter are configured and connected to drive different sets of the heating elements.

4. The hairstyling apparatus of claim 1, wherein the power electronic converter is configured to output a fixed output voltage for a range of mains power supply voltages.

5. The hairstyling apparatus of claim 1, configured such that an output voltage of the power electronic converter is varied at least partly in reliance on a currently selected mode or setting of the hairstyling apparatus.

6. The hairstyling apparatus of claim 1, wherein the power electronic converter is an AC to DC converter.

7. The hairstyling apparatus of claim 1, wherein the power electronic converter is an AC to AC converter.

8. The hairstyling apparatus of claim 1, wherein the power electronic converter is a buck converter, a boost converter, or a buck-boost converter.

9. The hairstyling apparatus of claim 1, comprising a power factor correction circuit for power factor correction of the power electronic converter and associated load(s).

10. The hairstyling apparatus of claim 1, wherein the power electronic converter is capable of accepting a mains power supply having an AC voltage of 85 VAC to 265 VAC.

11. A method of controlling a power output of a hairstyling apparatus, wherein the hairstyling apparatus comprises:
a heater comprising at least one heating element; and
a power electronic converter for converting a mains power supply to a heater drive signal for driving the heater;
the method comprising:
determining a voltage of a mains power supply to which the hairstyling apparatus is connected; and
controlling the power electronic converter at least partly in reliance on the voltage determined voltage.

12. The method of claim 11, wherein the hairstyling apparatus further comprises a heating element drive circuit that does not form part of the power electronic converter, and the method further comprises generating, with the heating element drive circuit, a further drive signal for driving at least one of the at least one heating elements.

13. The method of claim 12, further comprising driving different sets of the heating elements with the heating element drive circuit and the power electronic converter.

14. The method of claim 11, wherein controlling the power electronic converter comprises outputting a fixed output voltage for a range of input voltages.

15. The method of claim 11, wherein controlling the power electronic converter comprises varying an output voltage of the power electronic converter at least partly in reliance on a currently selected mode or setting of the hairstyling apparatus.

16. The method of claim 11, further comprising converting, using the power electronic converter, the mains supply to an AC heater drive signal.

17. The method of claim 11, further comprising converting, using the power electronic converter, the mains supply to a DC heater drive signal.

18. The method of claim 11, further comprising applying power factor correction.
